(19) United States
(12) Patent Application Publication
(10) Pub. No.: US 2025/0040534 A1
(43) Pub. Date: Feb. 6, 2025

(54) Mechanical Device to Selectively Defoliate Lawn Weeds

(71) Applicant: Edward Leslie Jones, Cincinnati, OH (US)

(72) Inventor: Edward Leslie Jones, Cincinnati, OH (US)

(21) Appl. No.: 18/445,366

(22) Filed: Aug. 2, 2023

(51) Int. Cl. A01M 21/02

(52) U.S. Cl. CPC A01M 21/02; A01B 45/026; A01G 20/30

(57) ABSTRACT

A mechanical device is presented to mechanically remove weeds in a lawn instead of chemical herbicides. The inventive device utilizes a motor driven horizontal spindle with a large number of closely spaced strings of equal length are attached turning at high speed which do the cutting. The vertically rotating strings selectively defoliates any vegetation that has lateral shoots or broad leaves. Turf grasses have narrow leaves and minimal lateral growth and so allow the rotating strings to pass through with little resistance like a comb going through hair and causes much less damage to the grass leaves. The horizontal spindle can be as long as desired covering a wide path through the lawn as long as the motor has enough power to handle the workload.

### BACKGROUND OF THE INVENTION

### Field of the Invention

Weeds in a lawn spoil the cosmetic appearance and chemical herbicides are the usual method of controlling lawn weeds but are not without disadvantages such as cost, effectiveness and hazards in handling and environmental issues. This invention provides an alternative to using chemical herbicides. In addition there are areas where chemical herbicides cannot be used where they can damage desirable ornamental shrubs or trees whose roots are in areas of the lawn. This invention will selectively defoliate weeds and quickly improve the cosmetic appearance of the lawn.

### Prior Art

US20150201607A1 and US10058087B2 are selective mechanical devices consisting a base with a plurality of grooves, a brush rotating about a horizontal axis with a plurality of bristles of different lengths along with circular cutters, augers and a roller. In this device the brush pushes the vegetation into the grooved base knifes to help abrade and defoliate exposed and undesirable vegetation. This device has no expensive grooved base and or brush but uses high speed vertically rotating strings to do the cutting. This device uses a horizontal spindle holding a plurality of strings set close together and rotated at a speed fast enough to cut vegetation as in a string trimmer. It doesn't kill the weed outright but defoliates the plant which starves the plant. The object of the invention is to mechanically defoliate weeds and starve them out. It doesn't kill the weed plant, it only defoliates the plant which may regrow from the roots. However with repeated treatment as new growth emerges from the roots they will not survive.

The primary object of the invention is to selectively defoliate the weed plants using vertically rotating strings while doing minimal damage to the grass. “resistant vegetation” is defines as vegetation that impedes a string as it sweeps its path through the lawn. At high speed the strings become straight due to centrifugal force. The strings act like a comb going through the grass. The thin vertical blades of grass offer little resistance to the vertical strings and so are not subject to much damage. However any vegetation with broad leaves or lateral branching is highly vulnerable to the strings and are easily defoliated and thus creates the selectivity of this invention as many weed species fall into this category. It is powered by an corded AC electric motor but could also be powered by a gasoline engine, battery powered DC electric motor or by a tractor powered takeoff.

### Advantages

This invention
a. has fewer parts and so is simpler
b. less expensive
c. lighter weight
d. uses commonly available trimer string and is easily replaceable.
e. Reduces the need for herbicides and the environmental problems and handling issues.

In my PPA my invention had one rotating spindle but adding a second spindle was easy and improves the defoliation efficiency.

It ends up looking like a typical lawn mower as well.

### PREFERRED EMBODIMENT

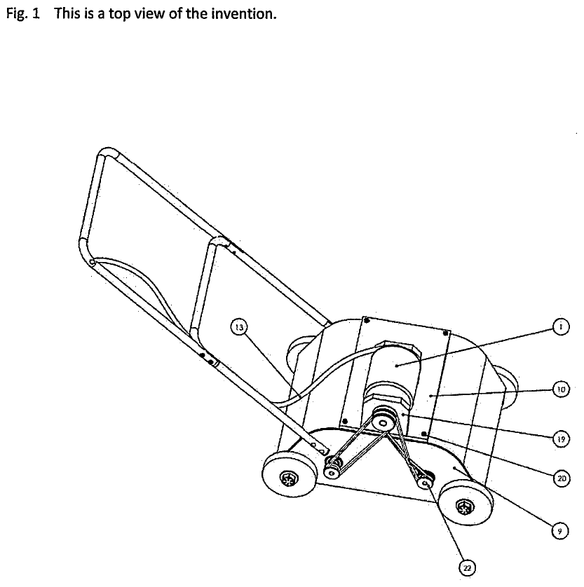

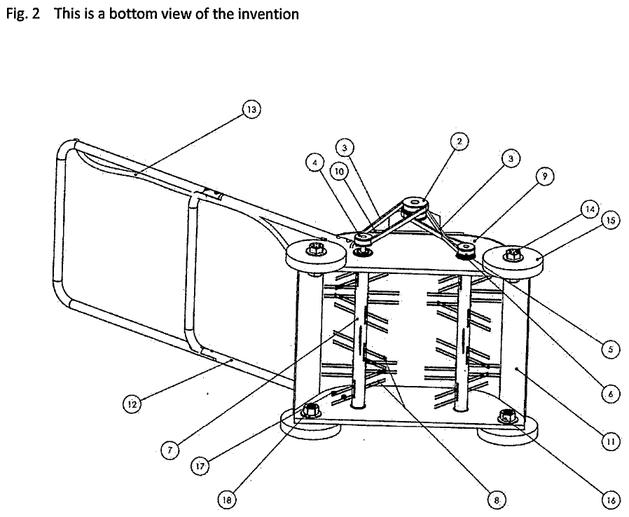

The body of this invention shown in FIGS. 1 and 2 consists of a plywood top plate 17×8 inches (10) screws to two 23×9 inch side plates (9). Sandwiched between them is an ⅛ inch thick polyethylene sheet (11) as a shield which was heat formed to match the curve on the side plates. A 1 h/p 1725 rpm electric motor (1) is mounted on top with a motor mount (19) with its cord (13) leading up a lawn mower handle (12) bolted to the side plates with two ⅜ inch bolts (17) at a 140 degree angle. The electric motor should be thermally protected since hot daytime temperatures could possibly overheat the motor. Four 6 inch wheels (15) were bolted to the sides with ½ inch bolts (14) with washers (18). The electric motor was fitted with a 2.55 inch dual pulley (2) to drive a 1.75 inch pulley on each spindle using 3 L V belts (3) giving a 2320 rpm spindle speed. 3 L are more flexible than the standard 4 L V belt and don't need to transmit a lot of power.

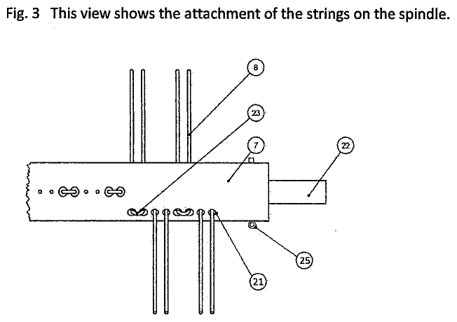

In FIG. 3 each string spindle (7) is a 1.25 inches OD Delrin rod and has a ½ inch central hole drilled into each end to fit a ½ inch steel shaft (22). A ⅛ inch hole is through the spindle and shaft for a cotter pin (25) to lock the shaft. Holes 0.068 inch diameter are drilled every ¼ inch all along the spindle to hold the strings (8). A 12 inch piece of string is cut, folded in two and then fed through two adjacent holes forming a tight loop (23). This tight loop keeps the string from being pulled out in use but can be easily removed and replaced and centrifugal force will keep them in place. After every set of four strings the holes are staggered 30 degrees (clocked) and another set of four strings are drilled forming a spiral. This is so that all the strings on one side don't hit the ground at the same time causing vibration in the V belts. Also every other string pair is inserted from the opposite side to be sure the spindle is balanced. It's very important that the exit hole for strings (21) are rounded off or else the sharp edge of the drilled hole will quickly cause the string to break. I used a 3 mm radius rounding end mill to form a rounded exit hole (24) which greatly extends the life of the strings and a longer radius is likely better. Flanged ½ inch ID ball bearings (6) are inserted into holes drilled into the side plates to hold the spindle shafts. The spindle shafts are kept in place by locking collars (5) or one of the small pulleys. The string spindle can also be removed by pulling the cotter pins and pulling the shafts out of the spindle if needed.

The preferred direction of rotation of the spindles is important. The front spindle should rotate clockwise so that clippings are not thrown forward and impede the work of the strings. The front spindle rotating clockwise tends to lay the grass down and so the rear spindle should rotate counter-clockwise to counter this and should be more effective but at least it won't throw clippings back at the operator. So to have counter-rotating spindles the V belt on the first spindle is crossed which rotates the front spindle clockwise with the motor turning counter-clockwise. The rear spindle will rotate counter-clockwise with the counter-clockwise motor. Having two spindles will increase the effectiveness and reduce the need for second passes if weeds are missed.

### Operation

Using the lawn mower is very much like using a lawn mower except that if you have to stop you should switch the motor off because even though the grass is resistant to the rotating strings stopping in one spot will eventually begin to damage the grass as well. It is best to first mow the grass so that the strings will be more efficient. A vigorously growing lawn forces the weed leaves higher making them easier to defoliate whereas low lying weed are harder to remove. Making several passes is not detrimental if needed.

### String Replacement

The strings will last much longer than the strings of a weed eater with the exit holes properly rounded but will eventually need to be replaced. With a pair of pliers grab the end loop to pull the string pair. Fold a 12 inch length of string in two and push it back into the same holes making sure the exit holes are rounded. You could also pull the cotter pins then pull the shafts to replace the whole string spindle.

1. An apparatus for defoliating lawn and turf grass weeds, comprising at least one spindle rotating about a horizontal axis holding a plurality of strings rotating vertically and a means to rotate said spindle at high speed wherein the improvement consists of the use of high speed cutting strings resulting in said apparatus having fewer necessary mechanical parts.

2. The strings of claim 1 wherein are rotated at a speed high enough to cut any resisting vegetation.

3. The strings of claim 1 wherein are spaced along the spindle close enough to adequately clear resisting vegetation in a path the width of the strings on the spindle.
